(19) United States
(12) Patent Application Publication
(10) Pub. No.: US 2026/0099018 A1
(43) Pub. Date: Apr. 9, 2026

(54) SEMICONDUCTOR PACKAGE STRUCTURE

(71) Applicant: BE Epitaxy Semiconductor Technology Co., Ltd., Kaohsiung City (TW)

(72) Inventors: Yi-Chen WU, Kaohsiung City (TW); Po-Hsiang HUANG, Kaohsiung City (TW); Yung-Jr HUNG, Kaohsiung City (TW); Ann-Kuo CHU, Kaohsiung City (TW); Yi-Jie WANG, Kaohsiung City (TW)

(21) Appl. No.: 19/352,476

(22) Filed: Oct. 8, 2025

Related U.S. Application Data
(60) Provisional application No. 63/704,681, filed on Oct. 8, 2024.

(30) Foreign Application Priority Data
Dec. 24, 2024 (TW) 113150471

(51) Int. Cl. G02B 6/42

(52) U.S. Cl. CPC G02B 6/4214

(57) ABSTRACT

A semiconductor package structure includes a photonic integrated circuit chip and a fiber array unit. The photonic integrated circuit chip includes an optical waveguide, a grating coupler, and a dielectric structure. The grating coupler is connected to the optical waveguide. The dielectric structure is located on the optical waveguide and the grating coupler and has a first positioning member located on an upper surface of the dielectric structure. The fiber array unit is located on the photonic integrated circuit chip and includes a fiber holder and an optical fiber. The fiber holder has a second positioning member located on a lower surface of the fiber holder, in which the first positioning member and the second positioning member fit together. The optical fiber is fixed to the fiber holder and optically coupled to the grating coupler.

### CROSS-REFERENCE TO RELATED APPLICATION

This application claims priority to US Provisional Application Ser. No. 63/704,681, filed Oct. 8, 2024, and Taiwan Application Serial Number 113150471, filed Dec. 24, 2024, the disclosures of which are incorporated herein by reference in their entireties.

### BACKGROUND

### Field of Invention

The present disclosure relates to a semiconductor package structure. More particularly, the present disclosure relates to the semiconductor package structure having a positioning member and/or a fastening device.

### Description of Related Art

Electrical signal transmission and processing technologies are traditionally used for signal transmission and processing. However, with the advancement in technology, optical signal transmission and processing technologies are being increasingly adopted in a broad range of applications. Especially in the applications of fiber optic technology, optical signal transmission exhibits a great potential. Optical fiber has the advantages of high transmission rate and less signal loss, so it is an ideal choice for long-distance signal transmission, processing, and control. Therefore, optical fiber technology is becoming increasingly widespread in modern communications, especially in the transmission and processing of optical signals. The primary advantages of optical fiber technology include its good transmitting capacity and low attenuation characteristics, enabling high-quality signal transmission over long distances. In addition, optical fiber packing technology (including the packing structure that integrates optical fibers with semiconductor components) can be widely used in many fields, especially in the field of fiber optic communications. This technology can achieve more efficient data transmission and processing, further promoting the development of modern communication technologies.

### SUMMARY

The semiconductor package structure provided by the present disclosure includes a photonic integrated circuit chip and a fiber array unit located on the photonic integrated circuit chip, wherein a fiber array unit (FAU) is detachable, so the replaceability of the fiber array unit can be increased. If the fiber array unit is damaged, only the damaged fiber array unit needs to be replaced, without the need to replace the entire structure of the fiber array unit and the photonic integrated circuit chip. Specifically, there is a first positioning member on the photonic integrated circuit chip and a second positioning member on the fiber array unit. The fiber array unit is passively aligned and arranged on the photonic integrated circuit chip by the first positioning member and the second positioning member that fit together, thereby increasing the accuracy and efficiency of the semiconductor package structure.

The semiconductor package structure provided by the present disclosure fixes the photonic integrated circuit chip and the fiber array unit together by a fastening device to increase the strength of the semiconductor package structure.

The present disclosure provides a semiconductor package structure including a photonic integrated circuit chip and a fiber array unit. The photonic integrated circuit chip includes a first optical waveguide, a first grating coupler, and a dielectric structure. The first grating coupler is connected to the first optical waveguide. The dielectric structure is located on the first optical waveguide and the first grating coupler, and has a first positioning member located on the upper surface of the dielectric structure. The fiber array unit is located on the photonic integrated circuit chip and includes a fiber holder and a first optical fiber. The fiber holder has a second positioning member located on a lower surface of the fiber holder, wherein the first positioning member and the second positioning member fit together. The first optical fiber is fixed to the fiber holder and optically coupled to the first grating coupler.

In some embodiments, the first positioning member is a hole recessed into the upper surface of the dielectric structure, and the second positioning member is a locating pin protruding from the lower surface of the fiber holder.

In some embodiments, the first positioning member is a locating pin protruding from the upper surface of the dielectric structure, and the second positioning member is a hole recessed into the lower surface of the fiber holder.

In some embodiments, the first positioning member and the second positioning member both extend in a vertical direction.

In some embodiments, an extension direction of the optical fiber is substantially parallel to an extension direction of the upper surface of the photonic integrated circuit chip.

In some embodiments, the optical fiber is adjacent to a first sidewall of the fiber holder, and the second positioning member is adjacent to a second sidewall of the fiber holder, wherein the first sidewall is disposed opposite to the second sidewall.

In some embodiments, the fiber holder further includes a reflective mirror and a first microlens. The reflective mirror is located in the fiber holder and is further optically coupled the first optical fiber to the first grating coupler. The first microlens is optically coupled between the reflective mirror and the first grating coupler, wherein the first microlens is recessed into or protruding from the lower surface of the fiber holder.

In some embodiments, the photonic integrated circuit chip further includes a second microlens. The second microlens is optically coupled between the reflective mirror and the first grating coupler and separated from the first positioning member, wherein the second microlens is recessed into the upper surface of the dielectric structure.

In some embodiments, the second microlens is substantially aligned with the first microlens in a vertical direction.

In some embodiments, the photonic integrated circuit chip further includes a second optical waveguide and a second grating coupler. The second grating coupler is connected to the second optical waveguide, wherein the dielectric structure is located on the second optical waveguide and the second grating coupler. The fiber array unit further includes a second optical fiber. The second optical fiber is fixed to the fiber holder, wherein the reflective mirror of the fiber array unit is further optically coupled the second optical fiber to the second grating coupler, and the first optical fiber and the second optical fiber extend along a same direction. The fiber holder further includes a second microlens. The second microlens is optically coupled between the reflective mirror and the second grating coupler, and separates from the second positioning member and the first microlens, wherein the first microlens and the second microlens both are recessed into the lower surface of the fiber holder.

In some embodiments, the semiconductor package structure further includes a fastening substrate, a fastener, and a fastening holder. The photonic integrated circuit chip and the fiber holder are located on the fastening substrate. The fastener contacts the upper surface of the fiber holder and provides a downward force toward the fiber holder. The fastening holder is located on the fastening substrate and supports the fastener.

In some embodiments, the fastener is a screw or a spring clip.

In some embodiments, the first grating coupler is a one-dimensional grating coupler or a two-dimensional grating coupler.

The present disclosure provides a semiconductor package structure including a photonic integrated circuit chip, a fiber array unit, and a fastening device. The photonic integrated circuit chip includes an optical waveguide and a grating coupler connected to the optical waveguide. The fiber array unit is located on the photonic integrated circuit chip and includes a fiber holder and an optical fiber fixed to the fiber holder, wherein the optical fiber is optically coupled to the grating coupler. The fastening device includes a fastening substrate, a fastener, and a fastening holder. The photonic integrated circuit chip and the fiber holder are located on the fastening substrate. The fastener contacts the upper surface of the fiber holder and provides a downward force toward the fiber holder. The fastening holder is located on the fastening substrate and supports the fastener.

In some embodiments, the fastener is a screw or a spring clip.

In some embodiments, the photonic integrated circuit chip further includes a dielectric structure located on the optical waveguide and the grating coupler, the photonic integrated circuit chip has a first positioning member located on an upper surface of the dielectric structure and the fiber holder has a second positioning member located on a lower surface of the fiber holder, and the first positioning member and the second positioning member fit together.

In some embodiments, the first positioning member is a first hole recessed into the upper surface of the dielectric structure, and the second positioning member is a first locating pin protruding from the lower surface of the fiber holder.

In some embodiments, the photonic integrated circuit chip has a third positioning member located on the upper surface of the dielectric structure and the fiber holder has a fourth positioning member located on the lower surface of the fiber holder, and the third positioning member and the fourth positioning member fit together.

In some embodiments, the third positioning member is a second hole recessed into the upper surface of the dielectric structure, and the fourth positioning member is a second locating pin protruding from the lower surface of the fiber holder.

In some embodiments, an extension direction of the optical fiber is substantially parallel to an extension direction of an upper surface of the photonic integrated circuit chip.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a cross-sectional view of a semiconductor package structure in accordance with the first embodiment of the present disclosure.

FIG. 2 is a cross-sectional view of a semiconductor package structure in accordance with the second embodiment of the present disclosure.

FIG. 3 is a cross-sectional view of a semiconductor package structure in accordance with the third embodiment of the present disclosure.

FIG. 4 is a cross-sectional view of a semiconductor package structure in accordance with the fourth embodiment of the present disclosure.

FIG. 5 is a cross-sectional view of a semiconductor package structure in accordance with the fifth embodiment of the present disclosure.

FIG. 6A is a three-dimensional view of a semiconductor package structure in accordance with one embodiment of the present disclosure.

FIG. 6B is a partial top view of FIG. 6A.

FIG. 6C is a cross-sectional view along a line A-A′ in FIG. 6B.

FIG. 6D is a side view along a line B-B′ in FIG. 6B.

FIG. 7 is a side view of a semiconductor package structure in accordance with one embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In addition, when a numerical value or a numerical range is described using terms such as “about”, “approximately”, “substantially” or other similar terms, such term is intended to indicate that the described values encompass a reasonable range of variation, as would be understood by one skilled in the art, for example, values within ±10% of the stated number or other numerical value. For example, a value described as “about 5 μm” is intended to encompass values in the range from 4.5 μm to 5.5 μm.

It will be understood that, although the terms “first,” “second,” etc. may be used herein to describe various elements, these elements should not be limited by these terms. These terms are only used to distinguish one element from another. For example, a “first element” may be termed a “second element,” and, similarly, a “second element” may be termed a “first element,” without departing from the scope of the embodiments. As used herein, the term “and/or” includes any and all combinations of one or more of the associated listed items.

Several embodiments of the present disclosure will be illustrated with reference to the accompanying drawings. For the sake of clarity, various practical details are included in the following description. However, it should be understood that such practical details are not intended to limit the scope of the present disclosure. In other words, in certain embodiments of the present disclosure, these practical details may not be necessary. Furthermore, for the sake of simplicity, certain conventional structures and components are illustrated in the drawings in a simplified schematic manner.

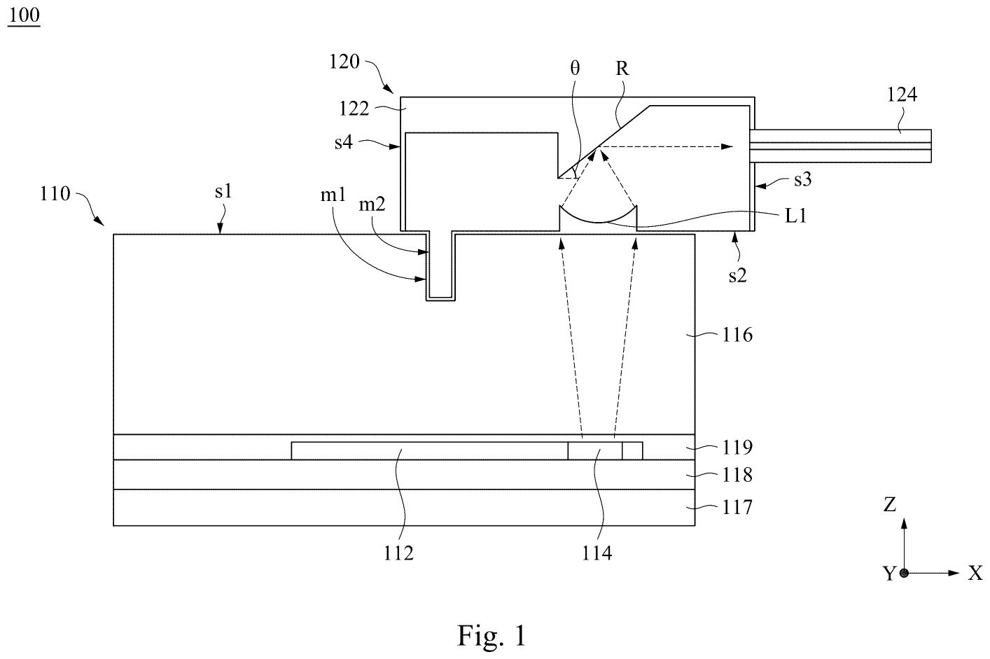

FIG. 1 is a cross-sectional view of a semiconductor package structure 100 in accordance with the first embodiment of the present disclosure. The semiconductor package structure 100 includes a photonic integrated circuit chip 110 and a fiber array unit 120. The photonic integrated circuit chip 110 includes an optical waveguide 112, a grating coupler 114, and a dielectric structure 116. The grating coupler 114 is connected to the optical waveguide 112. The dielectric structure 116 is located on the optical waveguide 112 and the grating coupler 114 and has a positioning member m1 located on an upper surface s1 of the dielectric structure 116. The dielectric structure 116 may be made of one or more insulating or passivation layers. The material of the dielectric structure 116 may be silicon oxide, nitride oxide, other possible materials, or combinations thereof. The fiber array unit 120 is located on the photonic integrated circuit chip 110 and includes a fiber holder 122 and an optical fiber 124. The fiber holder 122 has a positioning member m2 located on a lower surface s2 of the fiber holder 122, wherein the positioning member m1 and the positioning member m2 fit together. The optical fiber 124 is fixed to the fiber holder 122 and optically coupled to the grating coupler 114. In the present disclosure, the positioning member m1 and the positioning member m2 can be collectively referred to as a “positioning structure.”

Referring to FIG. 1, the photonic integrated circuit chip 110 further includes a semiconductor substrate 117, a lower cladding layer 118, and an upper cladding layer 119. The semiconductor substrate 117 may be a bulk substrate, such as a single crystalline silicon substrate, a silicon-on-insulator (SOI) substrate, or some other suitable semiconductor substrates. The lower cladding layer 118 is disposed on the semiconductor substrate 117. The optical waveguide 112 and the grating coupler 114 are disposed on the lower cladding layer 118. The upper cladding layer 119 covers the optical waveguide 112 and the grating coupler 114 and surrounds around the optical waveguide 112 and the grating coupler 114. The optical waveguide 112 and the grating coupler 114 may include suitable semiconductor materials, such as silicon or silicon germanium. The lower cladding layer 118 and the upper cladding layer 119 may include suitable dielectric materials, such as silicon dioxide, silicon oxynitride, or silicon carbide. The refractive indices of the lower cladding layer 118 and the upper cladding layer 119 are different from a refractive index of the optical waveguide 112. Through the design of the refractive index difference, the light can be propagated in the optical waveguide 112.

In certain embodiments, the grating coupler 114 may include a plurality of semiconductor bumps arranged periodically (for example, separated by the upper cladding layer 119), and can couple the light into the optical waveguide 112 for propagation through grating diffraction. During the manufacturing process, the grating coupler 114 and the optical waveguide 112 may be formed by patterning a same semiconductor layer and therefore the grating coupler 114 and the optical waveguide 112 have the same refractive index.

In certain embodiments, the photonic integrated circuit chip 110 further includes a plurality of transistors (not illustrated) disposed on the semiconductor substrate 117 and under the dielectric structure 116. The channel layers of the transistors may have the same semiconductor material as that of the optical waveguide 112, such as silicon or silicon germanium. During the manufacturing process, the channel layers of the transistors and the optical waveguide 112 may be formed by patterning a same semiconductor layer.

In certain embodiments, the dielectric structure 116 may be formed by a plurality of stacked dielectric layers. The photonic integrated circuit chip 110 further includes metal interconnect features (not illustrated), such as metal wires and metal vias, disposed in the plurality of dielectric layers of the dielectric structure 116. These metal interconnect features (not illustrated) may be electrically connected to the transistors on the semiconductor substrate 117 to form various circuits.

In some examples, a size of the grating coupler 114 is about 10 μm to about 20 μm, such as 15 μm, but is not limited thereto. In some examples, a distance between the grating coupler 114 and the upper surface s1 of the dielectric structure 116 is about 700 μm, but is not limited thereto. In some examples, the material of the dielectric structure 116 may be, for example, an insulting material.

As shown in FIG. 1, the positioning member m1 is a hole recessed into the upper surface s1 of the dielectric structure 116, and the positioning member m2 is a locating pin protruding from the lower surface s2 of the fiber holder 122. In some embodiments, the positioning member m1 and the positioning member m2 both have a height of about 10 μm to about 200 μm, such as 50 μm, 100 μm, or 150 μm, but is not limited thereto. If the height of both the positioning member m1 and the positioning member m2 were less than 10 μm, the fiber array unit 120 may not be stably disposed on the photonic integrated circuit chip 110. In the first embodiment of FIG. 1, the positioning member m1 and the positioning member m2 both extend in the vertical direction (i.e., the direction Z). However, in other embodiments, the positioning member m1 and the positioning member m2 may extend in other directions.

In the first embodiment of FIG. 1, because a width of the positioning member m1 is slightly greater than a width of the positioning member m2, there is a gap between the positioning member m1 and the positioning member m2. In other words, the positioning member m2 is not tightly fitted within the positioning member m1. Because there is the gap between the positioning member m1 and the positioning member m2, the relative positions of the photonic integrated circuit chip 110 and the fiber array unit 120 can be finely adjusted. In other words, the detachable fiber array unit 120 can increase the tolerance of the semiconductor package structure 100 during packaging. The fiber array unit 120 is passively aligned and disposed on the photonic integrated circuit chip 110, thereby increasing the accuracy and efficiency of the semiconductor package structure 100. Because the fiber array unit 120 is detachable, the replaceability of the fiber array unit 120 can be increased. For example, if the fiber array unit 120 is damaged, only the fiber array unit 120 needs to be replaced, without the need to replace the entire structure of the fiber array unit and the photonic integrated circuit chip. Therefore, compared to the semiconductor package structure that the fiber array unit is adhered to the photonic integrated circuit chip using optical cement, the semiconductor package structure 100 of the present disclosure has replaceability and can reduce manufacturing costs.

In some examples, the positioning member m1 in the dielectric structure 116 may be formed into a recessed hole on the upper surface s1 of the dielectric structure 116 by etching, laser, mechanical or other methods. In some examples, the materials of the positioning member m1 and the positioning member m2 may include, for example, silicon, silicon oxide, or combinations thereof, but are not limited thereto. In some examples, the positioning member m2 of the fiber holder 122 may be simultaneously formed with the fiber holder 122 by injection molding. In other examples, the positioning member m2 of the fiber holder 122 may be formed after forming the fiber holder 122, and the positioning member m2 may be formed on the lower surface s2 of the fiber holder 122 by etching, laser, mechanical or other methods. In some examples, the material of the fiber holder 122 may include, for example, glass, quartz, silicon, or combinations thereof, but is not limited thereto. The materials of the fiber holder 122 and the positioning member m2 may be the same or different.

Referring to FIG. 1, the fiber holder 122 further includes a reflective mirror R. The reflective mirror R is located in the fiber holder 122 and further optically coupled the optical fiber 124 to the grating coupler 114. The reflective mirror R is used to change the direction of light propagation so that the light enters into the optical fiber 124 parallel to the photonic integrated circuit chip 110. It could be understood that an angle θ of the reflective mirror R can be adjusted according to the actual coupling conditions. In some examples, the reflective mirror R of the fiber holder 122 may first be formed into an inclined plane by injection molding, and then a reflective material (for example, a metal material) is plated on the inclined plane.

In certain embodiments, the fiber holder 122 further includes a microlens L1. The microlens L1 is optically coupled between the reflective mirror R and the grating coupler 114, wherein the microlens L1 is recessed into the lower surface s2 of the fiber holder 122. The microlens L1 is used to narrow the beam size of the light from the grating coupler 114 to match the aperture size (for example, about 10 μm) of the optical fiber 124. Depending on the method of joining the fiber holder 122 and the optical fiber 124, a pitch of the optical fiber 124 may be, for example, 127 μm or 250 μm, but is not limited thereto.

In some examples, the material of the microlens L1 may include, for example, glass, quartz, silicon, or combinations thereof, but is not limited thereto. In some examples, the microlens L1 in the fiber holder 122 may be formed by etching, laser, mechanical or other methods. In some examples, a diameter of the microlens L1 may be about 40 μm or larger, but is not limited thereto. It could be understood that the size and curvature radius of the microlens L1 can be adjusted according to the actual coupling conditions.

In certain embodiments, the fiber holder 122 is used to install the optical fiber 124. In some examples, the optical fiber 124 may be directly adhered to a side of the fiber holder 122 by optical cement. In other examples, the optical fiber 124 may be joined using a v-groove formed on a side (lateral face) of the fiber holder 122, but is not limited to this joining method.

In certain embodiments, the optical fiber 124 and the upper surface s1 of the photonic integrated circuit chip 110 both extend along a substantially horizontal direction (i.e., the direction X). In other words, the extension direction of the optical fiber 124 is substantially parallel to the extension direction of the upper surface s1 of the photonic integrated circuit chip 110. Specifically, the reflective mirror R in the fiber holder 122 is used to change the direction of light propagation so that the optical fiber 124 can be disposed parallel to the upper surface s1 of the photonic integrated circuit chip 110. Compared to vertically arranging the optical fiber on the photonic integrated circuit chip, the semiconductor package structure 100 of the present disclosure has a smaller volume, which can increase the strength of the optical fiber 124 and reduce the risk of damage to the optical fiber 124.

In certain embodiments, the optical fiber 124 and the positioning member m2 are respectively adjacent to two opposite sides of the fiber array unit 120. Specifically, the optical fiber 124 is adjacent to a sidewall s3 of the fiber holder 122, and the positioning member m2 is adjacent to a sidewall s4 of the fiber holder 122, wherein the sidewall s3 is disposed opposite to the sidewall s4. In other words, the microlens L1 is located between the optical fiber 124 and the positioning member m2.

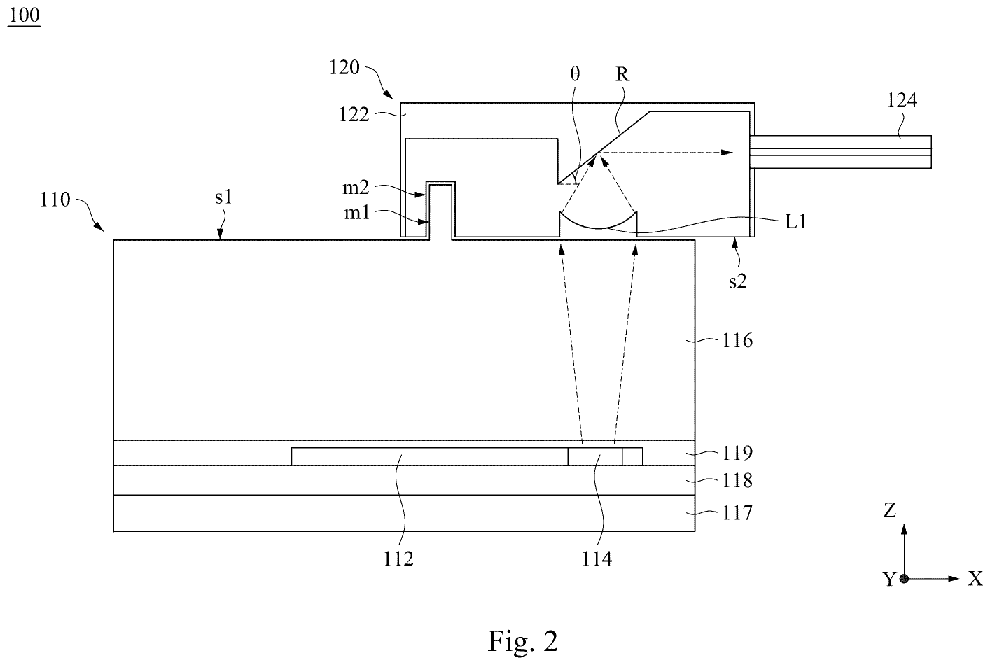

FIG. 2 is a cross-sectional view of a semiconductor package structure 100 in accordance with the second embodiment of the present disclosure. The semiconductor package structure 100 in FIG. 2 is similar to that in FIG. 1, except that the positioning member m1 in the second embodiment of FIG. 2 is a locating pin protruding from the upper surface s1 of the dielectric structure 116, and the positioning member m2 is a hole recessed into the lower surface s2 of the fiber holder 122. In the second embodiment of FIG. 2, because a width of the positioning member m2 is slightly greater than a width of the positioning member m1, there is a gap between the positioning member m1 and the positioning member m2. The relative positions of the photonic integrated circuit chip 110 and the fiber array unit 120 can be finely adjusted by using the gap. In the second embodiment of FIG. 2, the positioning member m1 and the positioning member m2 both extend substantially in the vertical direction (i.e., the direction Z). However, in other embodiments, the positioning member m1 and the positioning member m2 may extend in other directions. Other details of the present embodiment are generally as described in the first embodiment shown in FIG. 1, and thus will not be described again herein.

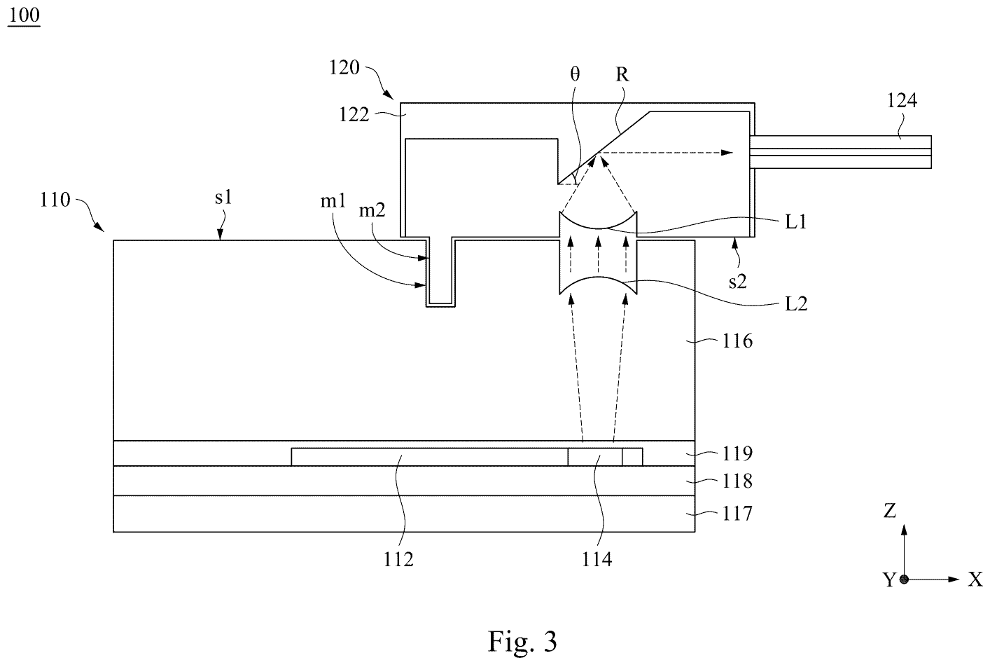

FIG. 3 is a cross-sectional view of a semiconductor package structure 100 in accordance with the third embodiment of the present disclosure. The semiconductor package structure 100 in FIG. 3 is similar to that in FIG. 1, except that the photonic integrated circuit chip 110 of the semiconductor package structure 100 in the third embodiment of FIG. 3 further includes a microlens L2. The microlens L2 is optically coupled between the reflective mirror R and the grating coupler 114 and separated from the positioning member m1, wherein the microlens L2 is recessed into the upper surface s1 of the dielectric structure 116. The microlens L2 is used to narrow the light from the grating coupler 114, for example, to make the output light collimated. As shown in FIG. 3, the microlens L2 is substantially aligned with the microlens L1 in the vertical direction (i.e., the direction Z). In some examples, the material of the microlens L2 may include, for example, silicon, silicon oxide, or combinations thereof, but is not limited thereto. In some examples, the microlens L2 may be formed by etching, laser, mechanical or other methods. It could be understood that the size and curvature radius of the microlens L2 can be adjusted according to the actual coupling conditions. Other details of the present embodiment are generally as described in the first embodiment shown in FIG. 1, and thus will not be described again herein.

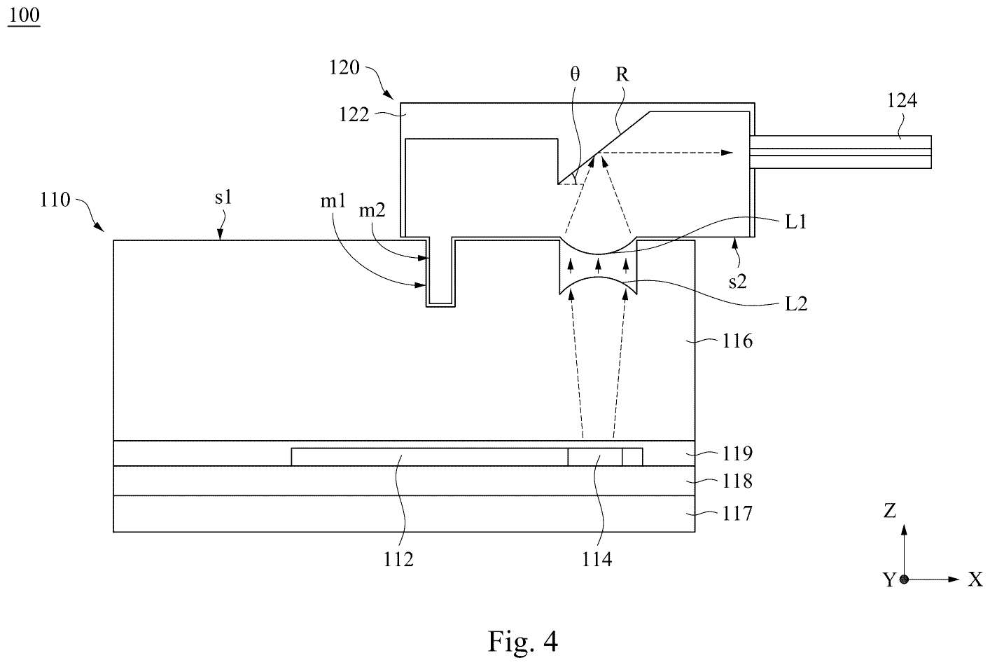

FIG. 4 is a cross-sectional view of a semiconductor package structure 100 in accordance with the fourth embodiment of the present disclosure. The semiconductor package structure 100 in FIG. 4 is similar to that in FIG. 3, except that the microlens L1 of the semiconductor package structure 100 in the fourth embodiment of FIG. 4 protrudes from the lower surface s2 of the fiber holder 122. Similar to the microlens L1 in FIG. 1 to FIG. 3, the microlens L1 in FIG. 4 is also optically coupled between the reflective mirror R and the grating coupler 114. Other details of the present embodiment are generally as described in the first embodiment shown in FIG. 1, and thus will not be described again herein.

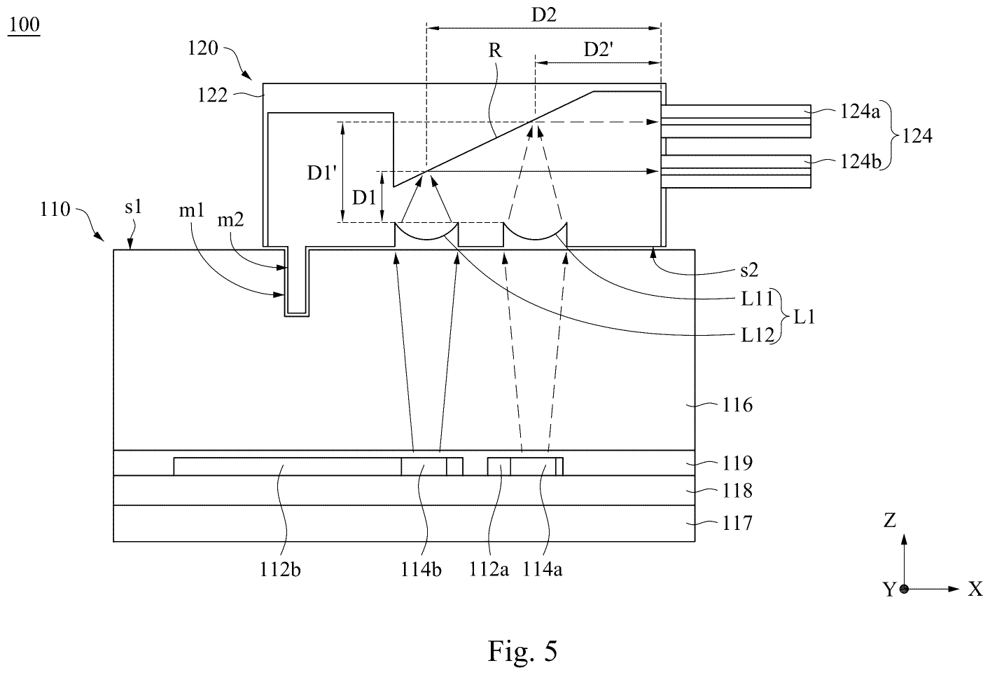

FIG. 5 is a cross-sectional view of a semiconductor package structure 100 in accordance with the fifth embodiment of the present disclosure. The semiconductor package structure 100 in FIG. 5 is similar to that in FIG. 1, except that the photonic integrated circuit chip 110 in the fifth embodiment of FIG. 5 can include a plurality of grating couplers 114 and a plurality of optical waveguides 112. The fiber holder 122 can include a plurality of microlenses L1, and the fiber array unit 120 can include a plurality of optical fibers 124. As illustrated, two grating couplers 114 are respectively labeled as the grating couplers 114a and 114b, two optical waveguides 112 are respectively labeled as the optical waveguides 112a and 112b, two microlenses L1 are respectively labeled as the microlenses L11 and L12, and two optical fibers 124 are respectively labeled as the optical fibers 124a and 124b. In certain embodiments, the plurality of grating couplers 114 may be arranged in an array on a plane formed by the directions X and Y, and the plurality of microlenses L1 may be arranged in an array on a plane formed by the directions X and Y, wherein directions X, Y, and Z are substantially perpendicular to each other. In certain embodiments, the grating coupler 114 may be a one-dimensional grating coupler or a two-dimensional grating coupler.

Specifically, referring to FIG. 5, the photonic integrated circuit chip 110 of the semiconductor package structure 100 includes the optical waveguide 112a, the grating coupler 114a, the optical waveguide 112b, and the grating coupler 114b. The grating coupler 114a is connected to the optical waveguide 112a, wherein the dielectric structure 116 is located on the optical waveguide 112a and the grating coupler 114a. The grating coupler 114b is connected to the optical waveguide 112b, wherein the dielectric structure 116 is located on the optical waveguide 112b and the grating coupler 114b. The optical waveguide 112a, the grating coupler 114a, the optical waveguide 112b, and the grating coupler 114b are all located in the upper cladding layer 119. The optical waveguide 112a and the grating coupler 114a are arranged separately from the optical waveguide 112b and the grating coupler 114b, as shown in FIG. 5.

Referring to FIG. 5, the fiber array unit 120 includes the optical fibers 124a and 124b. The optical fiber 124b is fixed to the fiber holder 122. The reflective mirror R of the fiber array unit 120 optically coupled the optical fiber 124a to the grating coupler 114a and optically coupled the optical fiber 124b to the grating coupler 114b. The optical fiber 124a and the optical fiber 124b extend along the same direction (i.e., the direction X). The optical fiber 124a and the optical fiber 124b are arranged along a substantially vertical direction (i.e., the direction Z).

Referring to FIG. 5, the fiber holder 122 includes the microlenses L11 and L12. The microlens L11 is optically coupled between the reflective mirror R and the grating coupler 114a, and the microlens L12 is optically coupled between the reflective mirror R and the grating coupler 114b. The microlens L11, the microlens L12, and the positioning member m2 are separated from each other, wherein the microlens L11 and the microlens L12 both are recessed into the lower surface s2 of the fiber holder 122. The materials and formation methods of the microlenses L11 and L12 may be the same as or similar to those of the microlens L1, and thus will not be described again herein.

Referring to FIG. 5, because the paths of the light emitted from the different grating couplers of the photonic integrated circuit chip 110 to the reflective mirror R through the fiber holder 122 are different, the sizes of the microlens L11 and the microlens L12 may be different in consideration of the focal lengths. Specifically, the optical paths of light emitted from the grating coupler 114a and the grating coupler 114b, reflected and reaching the optical fiber 124a and the optical fiber 124b may be different, thereby causing additional optical path difference and errors in signal processing. For example, the positions of the grating coupler 114b and the microlens L12 can be adjusted (such as, along the direction X and/or the direction Y) to make the two optical paths the same, thereby avoiding the optical path difference and the errors in signal processing. In other words, as shown in FIG. 5, a sum of the distance D1 and the distance D2 is substantially equal to a sum of the distance D1′ and the distance D2′. Other details of the present embodiment are generally as described in the first embodiment shown in FIG. 1, and thus will not be described again herein.

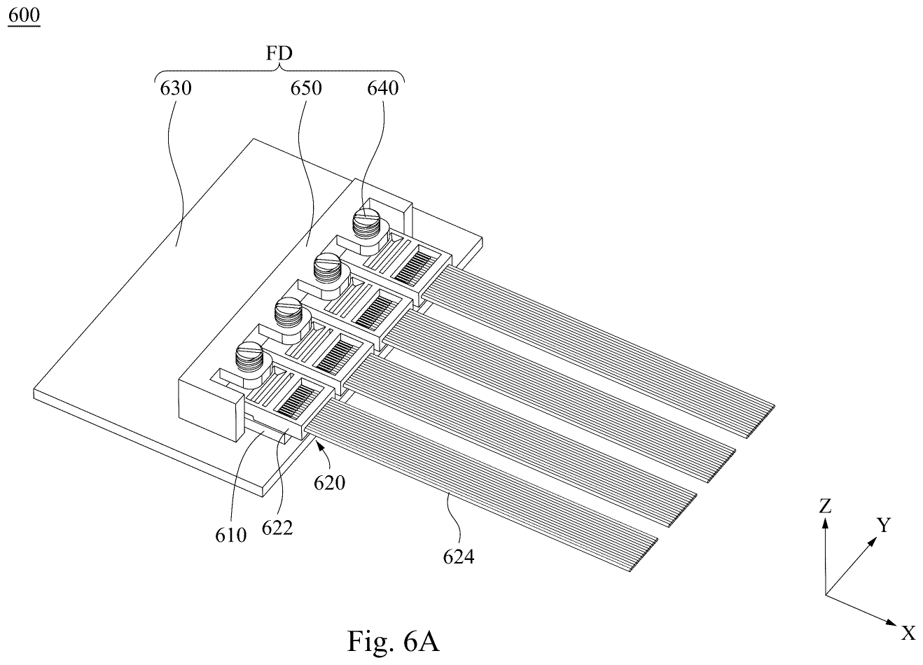

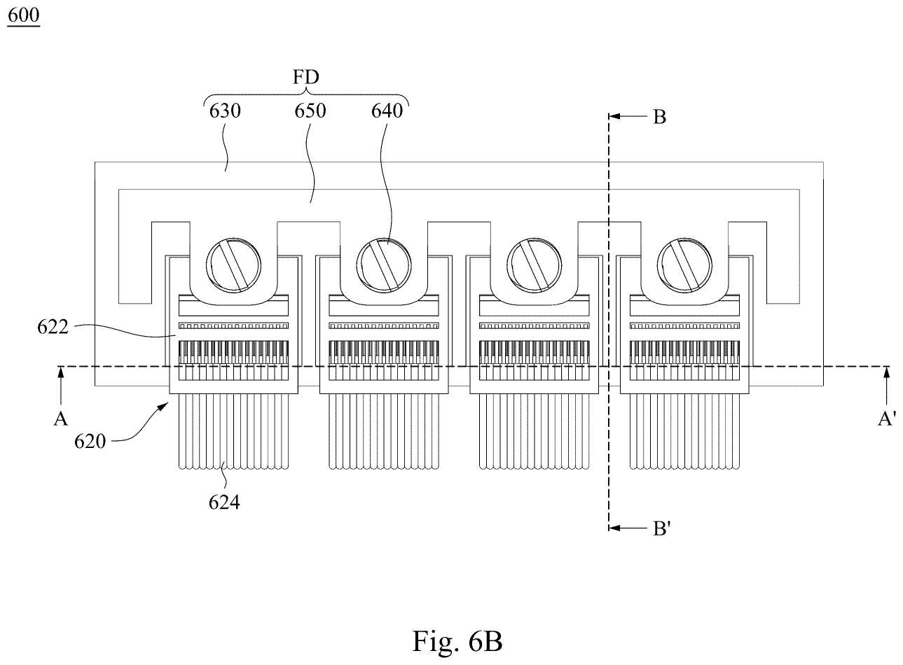

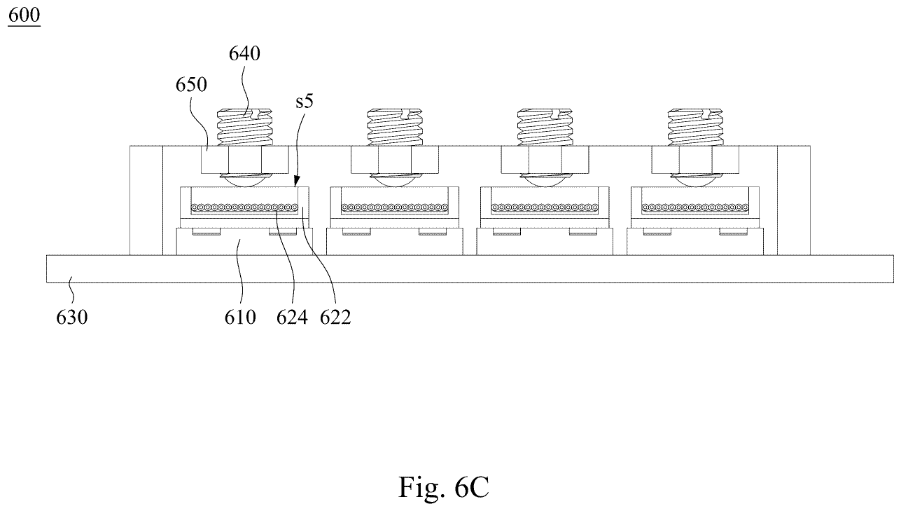

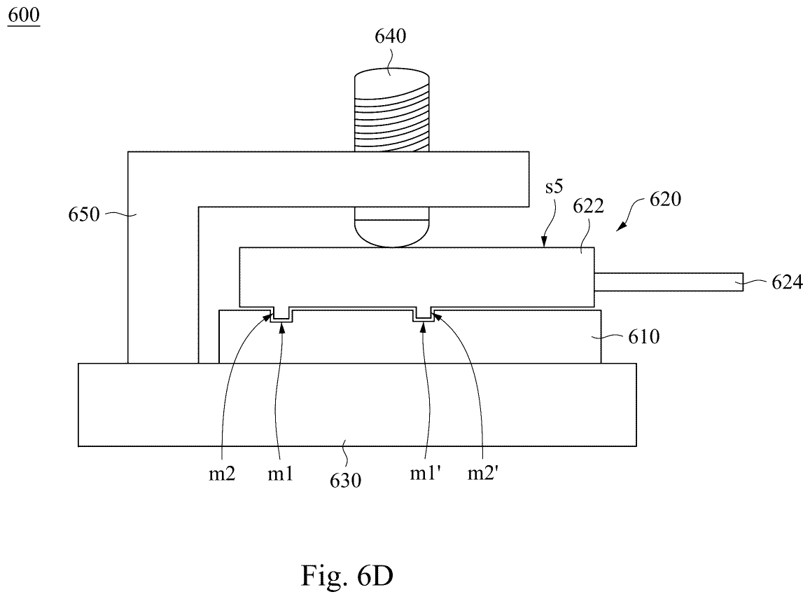

FIG. 6A is a three-dimensional view of a semiconductor package structure 600 in accordance with one embodiment of the present disclosure. FIG. 6B is a partial top view of FIG. 6A. FIG. 6C is a cross-sectional view along a line A-A′ in FIG. 6B. FIG. 6D is a side view along a line B-B′ in FIG. 6B.

Referring to FIG. 6A and FIG. 6B, the semiconductor package structure 600 includes a photonic integrated circuit chip 610, a fiber array unit 620, and a fastening device FD. The fastening device FD includes a fastening substrate 630, a fastener 640, and a fastening holder 650, wherein the fiber array unit 620 includes a fiber holder 622 and an optical fiber 624. Referring to FIG. 6A, the photonic integrated circuit chip 610 and the fiber holder 622 are located on the fastening substrate 630. It could be understood that the photonic integrated circuit chip 610 and the fiber array unit 620 in FIG. 6A can be replaced with the photonic integrated circuit chip 110 and the fiber array unit 120 in FIG. 1 to FIG. 5.

Referring to FIG. 6C and FIG. 6D, the fastener 640 contacts an upper surface s5 of the fiber holder 622 and provides a downward force (pressing force) toward the fiber holder 622. The fastening holder 650 is located on the fastening substrate 630 and supports the fastener 640. In the embodiment of FIG. 6A to FIG. 6D, the fastener 640 is a screw (such as, a precision screw). For example, the downward force of the precision screw on the fiber holder 622 is precisely adjusted by adjusting the precision screw.

In the embodiment of FIG. 6D, the semiconductor package structure 600 includes two sets of positioning structures. Specifically, the fiber holder 622 includes the positioning member m1 and the positioning member m2 that fit together and the positioning member m1′ and the positioning member m2′ that fit together.

Referring to FIG. 6D, during packaging the semiconductor package structure 600, the fiber array unit 620 is first disposed on the photonic integrated circuit chip 610, and then the relative positions of the fiber array unit 620 and the photonic integrated circuit chip 610 are finely adjusted by the gap(s) between the positioning member m1 and the positioning member m2 (as well as the positioning member m1′ and the positioning member m2′), so that the grating coupler (not illustrated) is aligned with the microlens (not illustrated). After that, the fastener 640 is used to provide downward force toward the fiber holder 622 to fix the photonic integrated circuit chips 610 and the fiber array unit 620.

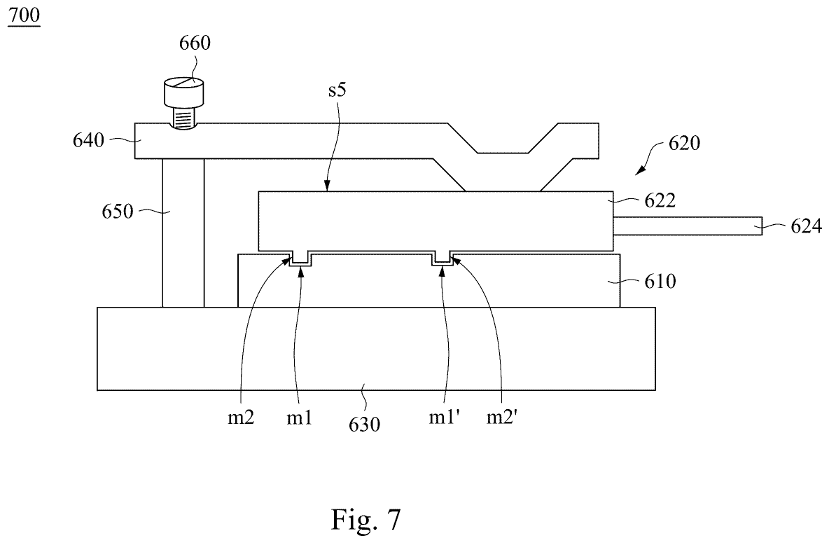

FIG. 7 is a side view of a semiconductor package structure 700 in accordance with one embodiment of the present disclosure. The present embodiment is similar to that in FIG. 6A to FIG. 6D, except that the fastener 640 in the present disclosure is a spring clip. Specifically, the semiconductor package structure 700 further includes a screw 660. The screw 660 (such as, a precision screw) is used to precisely adjust the downward force of the fastener 640 (the spring clip) on the fiber holder 622. Other details of the present embodiment are similar to those in the embodiment of FIG. 6A to 6D, and thus will not be described again herein.

In summary, the semiconductor package structure provided by the present disclosure has the positioning structure fitted together, such that the fiber array unit is passively aligned and disposed on the photonic integrated circuit chip, thereby increasing the accuracy and efficiency of the semiconductor package structure. Because the fiber array unit is detachable, it can increase the replaceability of the fiber array unit and reduce the manufacturing costs.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor package structure, comprising:
a photonic integrated circuit chip, comprising:
a first optical waveguide;
a first grating coupler connected to the first optical waveguide; and
a dielectric structure located on the first optical waveguide and the first grating coupler and having a first positioning member located on an upper surface of the dielectric structure; and
a fiber array unit located on the photonic integrated circuit chip, and comprising:
a fiber holder having a second positioning member located on a lower surface of the fiber holder, wherein the first positioning member and the second positioning member fit together; and
a first optical fiber fixed to the fiber holder and optically coupled to the first grating coupler.

2. The semiconductor package structure of claim 1, wherein the first positioning member is a hole recessed into the upper surface of the dielectric structure, and the second positioning member is a locating pin protruding from the lower surface of the fiber holder.

3. The semiconductor package structure of claim 1, wherein the first positioning member is a locating pin protruding from the upper surface of the dielectric structure, and the second positioning member is a hole recessed into the lower surface of the fiber holder.

4. The semiconductor package structure of claim 1, wherein the first positioning member and the second positioning member both extend in a vertical direction.

5. The semiconductor package structure of claim 1, wherein an extension direction of the optical fiber is substantially parallel to an extension direction of the upper surface of the photonic integrated circuit chip.

6. The semiconductor package structure of claim 1, wherein the optical fiber is adjacent to a first sidewall of the fiber holder, and the second positioning member is adjacent to a second sidewall of the fiber holder, wherein the first sidewall is disposed opposite to the second sidewall.

7. The semiconductor package structure of claim 1, wherein the fiber holder further comprises:
a reflective mirror located in the fiber holder and further optically coupled the first optical fiber to the first grating coupler; and
a first microlens optically coupled between the reflective mirror and the first grating coupler, wherein the first microlens is recessed into or protruding from the lower surface of the fiber holder.

8. The semiconductor package structure of claim 7, wherein the photonic integrated circuit chip further comprises:
a second microlens optically coupled between the reflective mirror and the first grating coupler and separated from the first positioning member, wherein the second microlens is recessed into the upper surface of the dielectric structure.

9. The semiconductor package structure of claim 8, wherein the second microlens is substantially aligned with the first microlens in a vertical direction.

10. The semiconductor package structure of claim 7, wherein the photonic integrated circuit chip further comprises:
a second optical waveguide; and
a second grating coupler connected to the second optical waveguide, wherein the dielectric structure is located on the second optical waveguide and the second grating coupler,
wherein the fiber array unit further comprises:
a second optical fiber fixed to the fiber holder, wherein the reflective mirror of the fiber array unit further optically couples the second optical fiber to the second grating coupler, and the first optical fiber and the second optical fiber extend along a same direction,
wherein the fiber holder further comprises:
a second microlens optically coupled between the reflective mirror and the second grating coupler and separated from the second positioning member and the first microlens, wherein the first microlens and the second microlens both are recessed into the lower surface of the fiber holder.

11. The semiconductor package structure of claim 1, further comprising:
a fastening substrate, wherein the photonic integrated circuit chip and the fiber holder are located on the fastening substrate;
a fastener contacting an upper surface of the fiber holder and providing a downward force toward the fiber holder; and
a fastening holder located on the fastening substrate and supporting the fastener.

12. The semiconductor package structure of claim 11, wherein the fastener is a screw or a spring clip.

13. The semiconductor package structure of claim 1, wherein the first grating coupler is a one-dimensional grating coupler or a two-dimensional grating coupler.

14. A semiconductor package structure, comprising:
a photonic integrated circuit chip comprising an optical waveguide and a grating coupler connected to the optical waveguide;
a fiber array unit located on the photonic integrated circuit chip and comprising a fiber holder and an optical fiber fixed to the fiber holder, wherein the optical fiber optically couples to the grating coupler; and
a fastening device, comprising:
a fastening substrate, wherein the photonic integrated circuit chip and the fiber holder are located on the fastening substrate;
a fastener contacting an upper surface of the fiber holder and providing a downward force toward the fiber holder; and
a fastening holder located on the fastening substrate and supporting the fastener.

15. The semiconductor package structure of claim 14, wherein the fastener is a screw or a spring clip.

16. The semiconductor package structure of claim 14, wherein the photonic integrated circuit chip further comprises a dielectric structure located on the optical waveguide and the grating coupler, the photonic integrated circuit chip has a first positioning member located on an upper surface of the dielectric structure and the fiber holder has a second positioning member located on a lower surface of the fiber holder, and the first positioning member and the second positioning member fit together.

17. The semiconductor package structure of claim 16, wherein the first positioning member is a first hole recessed into the upper surface of the dielectric structure, and the second positioning member is a first locating pin protruding from the lower surface of the fiber holder.

18. The semiconductor package structure of claim 16, wherein the photonic integrated circuit chip has a third positioning member located on the upper surface of the dielectric structure and the fiber holder has a fourth positioning member located on the lower surface of the fiber holder, and the third positioning member and the fourth positioning member fit together.

19. The semiconductor package structure of claim 18, wherein the third positioning member is a second hole recessed into the upper surface of the dielectric structure, and the fourth positioning member is a second locating pin protruding from the lower surface of the fiber holder.

20. The semiconductor package structure of claim 14, wherein an extension direction of the optical fiber is substantially parallel to an extension direction of an upper surface of the photonic integrated circuit chip.
